(19) United States
(12) Patent Application Publication
(10) Pub. No.: US 2009/0064208 A1
(43) Pub. Date: Mar. 5, 2009

(54) SSL socket builder

(76) Inventor: Thomas Mitchell Elrod, Peachtree City, GA (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/897,707

(22) Filed: Aug. 30, 2007

(51) Int. Cl. G06F 3/00

(52) U.S. Cl. 719/330

(57) ABSTRACT

A remoting client and a remoting server are described. In one embodiment, the remoting client forms a secured socket based on a set of SSL parameters and generating an invocation request with the secured socket to the remoting server. The set of SSL parameters is based on keys of a SSL socket builder of the remoting client. In another embodiment, the remoting server forms a secured server socket based on a set of SSL parameters and generates a response to an invocation request with the secured socket to the remoting client. The set of SSL parameters is based on keys of a SSL socket builder of the remoting client.

### TECHNICAL FIELD

Embodiments of the present invention relate to network communication, and more specifically to network based invocations.

### BACKGROUND

Remote procedure calls (RPC) allow a computer program to cause a subroutine or procedure to execute in another address space (commonly on another computer on a shared network) without the programmer explicitly coding the details for this remote interaction. That is, the programmer would write essentially the same code whether the subroutine is local to the executing program, or remote. When the software is written using object-oriented principles, RPC may also be referred to as remote invocation or remote method invocation.

Current remoting method invocations include, for example, RMI, EJB, and web services. The Java Remote Method Invocation API, or Java RMI, is a Java application programming interface for performing the object equivalent of remote procedure calls.

There are two common implementations of the API. The original implementation depends on Java Virtual Machine (JVM) class representation mechanisms and it thus only supports making calls from one JVM to another. The protocol underlying this Java-only implementation is known as Java Remote Method Protocol (JRMP). In order to support code running in a non-JVM context, a CORBA version was later developed. RMI may refer to the programming interface or may signify both the API and JRMP, whereas the term RMI-IIOP, read RMI over IIOP, denotes the RMI interface delegating most of the functionality to the supporting CORBA implementation.

The original RMI API was generalized somewhat to support different implementations, such as an HTTP transport. Additionally, work was done to CORBA, adding a pass by value capability, to support the RMI interface. Still, the RMI-IIOP and JRMP implementations are not fully identical in their interfaces.

A socket invoker or transport utitilizes available socket connections from a pool of sockets. However, it would be desirable to be able to configure the socket factories and server socket factories on both the server side and the client side to enable secure communication. A need therefore exists for an apparatus and a method to provide secure communication in remoting.

### BRIEF DESCRIPTION OF THE DRAWINGS

The present invention is illustrated by way of example, and not by way of limitation, in the figures of the accompanying drawings and in which:

FIG. 1 illustrates a network architecture in which embodiments of the present invention may be implemented.

FIG. 2 illustrates a block diagram of one embodiment of a remoting client.

FIG. 3 illustrates a block diagram of one embodiment of a remoting server.

FIG. 4 illustrates a block diagram of another embodiment of a network architecture.

FIG. 5 illustrates a block diagram of an exemplary computer system.

FIG. 6 illustrates a flow diagram of one embodiment of a method for supporting a secure communication between a remoting client and a remoting server.

FIG. 7 illustrates a flow diagram of another embodiment of a method for supporting a secure communication between a remoting client and a remoting server.

### DETAILED DESCRIPTION

Described herein is a method and apparatus for supporting a secure communication between a remoting client and a remoting server. An SSL socket builder provides an interface to different SSL bases. The SSL socket builder also provides a central storage location for configuration and parameters for the remoting server and the remoting client.

### General Architecture

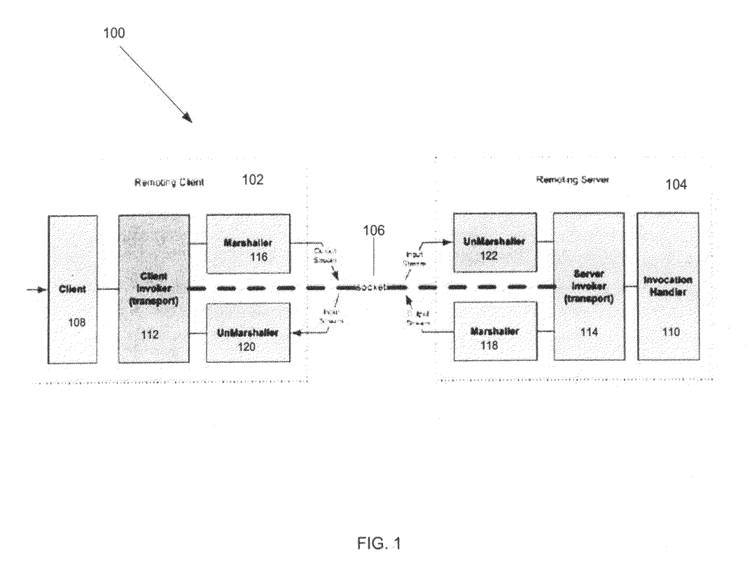

FIG. 1 illustrates an exemplary architecture 100 comprising a remoting client 102 coupled to a remoting server 104 via a network 106. A remoting framework with a single, simple application programming interface (API) for making network based invocations and other network related services is described. An example of a remoting framework is described in JBoss Remoting. The purpose of JBoss Remoting is to provide a single API for most network based invocations and related service that uses pluggable transports and data marshallers. The JBossRemoting API provides the ability for making synchronous and asynchronous remote calls, push and pull callbacks, and automatic discovery of remoting servers. The intention is to allow for the use of different transports to fit different needs, yet still maintain the same API for making the remote invocations and only requiring configuration changes, not code changes.

One important component of the JBoss Remoting architecture is how servers are identified. This is done via an InvokerLocator, which can be represented by a simple String with a URL based format (e.g., socket://myhost:5400). This is all that is required to either create a remoting server or to make a call on a remoting server. The remoting framework will then take the information embedded within the InvokerLocator and construct the underlying remoting components needed and build the full stack required for either making or receiving remote invocations.

Some examplary features of JBoss Remoting include server identification, pluggable transports, pluggable data marshallers, automatic discovery, server grouping, callbacks, asynchronous calls, local invocation, remote classloading, and sending of streams. In server identification, a simple string identifier allows for remoting servers to be identified and called upon. In pluggable transports, different protocol transports can be used such as socket, rmi, http, etc., via the same remoting API. In pluggable data marshallers, different data marshallers and unmarshallers can be used to convert the invocation payloads into desired data format for wire transfer. In automatic detection, remoting servers can be detected as they come on and off line. Server grouping gives the ability to group servers by logical domains, so that servers can only communicate within specified domains. Server callbacks can be received via push and pull models. Pull model allows for persistent stores and memory management. Asynchronous or one way calls can be made to the server. If an invocation on a remoting server that is within the same process space, remoting will automatically make this call by reference, to improve performance. Remote classloading allows for classes, such as custom marshallers, that do not exist within client to be loaded from the server. Sending of streams allows for cliens to send input streams to the server, which can be read on demand on the server.

There are several layers to this framework that mirror each other on the client and server side. The outermost layer is the one which the user interacts with—e.g. the remote access application. On the client side, this is the Client API 108 class upon which the user will make its calls. In other words, this can be the external API access point for client code. On the server side, this is the InvocationHandler 110, which is implemented by the user and is the ultimate receiver of invocation requests. Next is the transport, which is controlled by the invoker layers 112, 114. Finally, at the lowest layer are the Marshallers 116, 118 that convert data format to wire format and the UnMarshallers 120, 122 that convert wire format to data format.

When a user calls on the Client API 108 to make an invocation, it will pass this invocation request to the appropriate Client Invoker 112, based on the transport specified by the locator url. Client Invoker 112 will then use Marshaller 116 to convert the invocation request object to the proper data format to send over network 106 to Remoting Server 104.

On the server side, UnMarshaller 122 receives this data from the network 106, converts it back into a standard invocation request object, and sends it on to the Server Invoker 114. The Server Invoker 114 then passes this invocation request on to the user's implementation of the Invocation Handler 110. The response from Invocation Handler 110 passes back through Server Invoker 114 and on to Marshaller 118, which will then convert the invocation response object to the proper data format and send back to Remoting Client 102. UnMarshaller 120 on Remoting Client 102 converts the invocation response from wire data format into standard invocation response object, which will be passed back up through Client Invoker 112 and Client API 108 to the original caller.

### Remoting Client

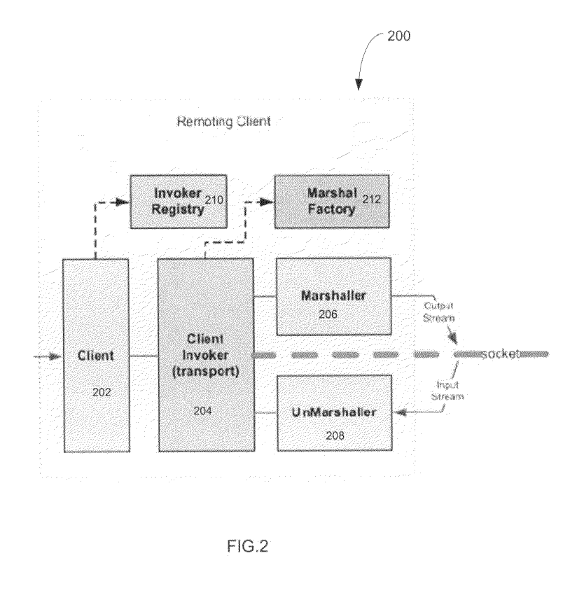

FIG. 2 illustrates a block diagram of one embodiment of a remoting client 200. For determining which client invoker to use, the Client API 202 will pass the InvokerRegistry 210 the locator for the target server it wishes to make invocations on. The InvokerRegistry 210 will return the appropriate client invoker instance based on information contained within the locator, such as transport type. The client invoker 204 will then call upon the MarshalFactory 212 to get the appropriate Marshaller 206 and UnMarshaller 208 for converting the invocation objects to the proper data format for wire transfer. All invokers have a default data type that can be used to get the proper marshal instances, but can be overridden within the locator specified.

### Remoting Server

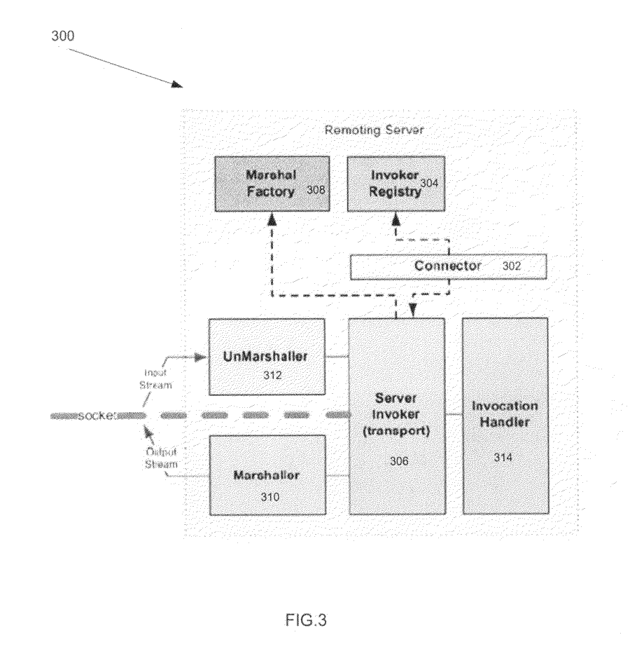

FIG. 3 illustrates a block diagram of one embodiment of a remoting server 300. On the server side, it is the Connector class 302 that is used as the external point for configuration and control of the remoting server 300. The Connector class 302 will call on the InvokerRegistry 304 with its locator to create a Server Invoker 306. Once the server invoker 306 is returned, Connector 302 then registers the invocation handlers 314 on it. Server Invoker 306 uses the MarshalFactory 308 to obtain the proper marshal instances, Marshaller 310, and UnMarshaller 312 as is done on the client side.

### Detection

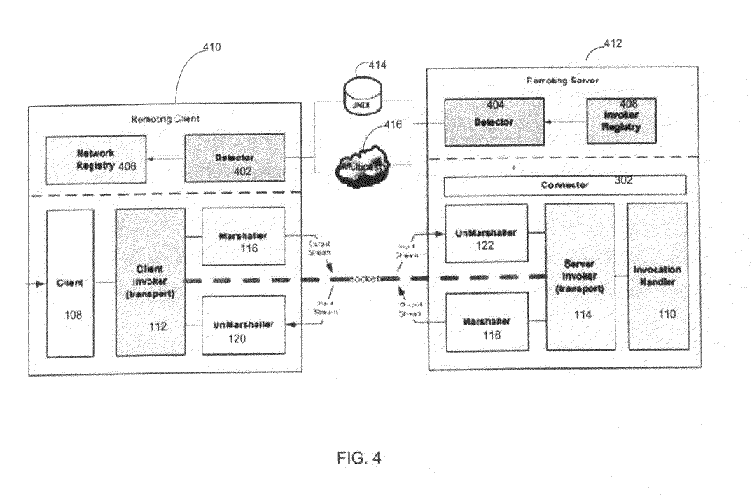

FIG. 4 illustrates a block diagram of another embodiment of a network architecture 400. To add automatic detection, a remoting Detector 402, 404 will need to be added on both the remoting client 410 and the remoting server 412. A Network Registry 406 is added to the remoting client 410. An Invoker Registry 408 is added to the remoting server 412.

When Detector 404 on the server side is created and started, it will periodically pull from the Invoker Registry 408 all the server invokers that it has created. The detector 404 will then use the information to publish a detection message containing the locator and subsystems supported by each server invoker. The publishing of this detection message may be either via a multicast broadcast or a binding into a JNDI server. On the client side, Detector 402 will either receive the multicast broadcast message or poll the JNDI server for detection messages. If Detector 402 determines a detection message is for a remoting server 412 that just came online, it will register it in the Network Registry 406. Network Registry 406 houses the detection information for all the discovered remoting servers. Network Registry 406 may also emit a JMX notification upon any change to this registry of remoting servers. The change to the Network Registry 406 can also be for when Detector 402 has discovered that a remoting server is no longer available and removes it from the registry.

### Machine Architecture

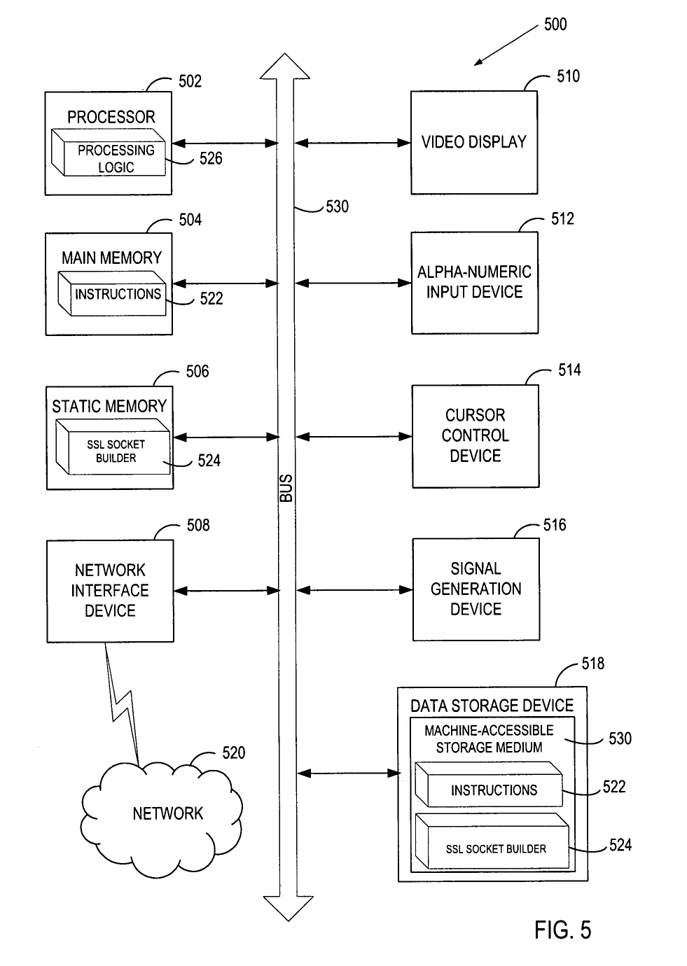

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium 530 on which is stored one or more sets of instructions (e.g., software 522) embodying any one or more of the methodologies or functions described herein. The software 522 may also reside, completely or at least partially, within the main memory 504 and/or within the processing device 502 during execution thereof by the computer system 500, the main memory 504 and the processing device 502 also constituting machine-accessible storage media. The software 522 may further be transmitted or received over a network 520 via the network interface device 508.

The machine-accessible storage medium 530 may also be used to store SSL socket builder 524 as described above. The SSL socket builder 524 may also be stored in other sections of computer system 500, such as static memory 506.

While the machine-accessible storage medium 530 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

### Server Socket Invoker

When the socket server invoker is started, it will create one, and only one, instance of java.net.ServerSocket. Upon being started, it will also create and start a number of threads to be used for accepting incoming requests from the ServerSocket. These threads are called the accept threads and the number of them created is controlled by the ‘numAcceptThreads’ property. When these accept threads are started, they will call accept( ) on the ServerSocket and block until the ServerSocket receives a request from a client, where it will return a Socket back to the accept thread who called the accept( ) method. As soon as this happens, the accept thread will try to pass off the Socket to another thread for processing.

The threads that actually process the incoming request, referred to as server threads, are stored in a pool. The accept thread will try to retreive the first available server thread from the pool and hand off the Socket for processing. If the pool does not contain any available server threads and the max pool size has not been reached, a new server thread will be created for processing. Otherwise, if the max pool size has been reached, the accept thread will wait for one to become available (will wait until socket timeout has been reached). The size of the server thread pool is defined by the ‘maxPoolSize’ property. As soon as the accept thread has been able to hand off the Socket to a server thread for processing, it will loop back to ServerSocket and call accept( ) on it again. This will continue until the socket server invoker is stopped.

The server thread processing the request will be the thread of execution through the unmarshalling of the data, calling on the server invocation handler, and marshalling of response back to the client. After the response has been sent, the server thread will then hold the socket connection and wait for another request to come from this client. It will wait until the socket is closed by the client, a socket timeout occurs, or receives another request from the client in which to process. When the client socket connection session is closed, meaning timeout or client closed socket connection, then the thread will return itself to the pool.

If all the server threads from the pool are in use, meaning have a client connection established, and the pool has reached its maximum value, the accept threads (no matter how many there are) will have to wait until one of the server threads is available for processing. This why having a large number of accept threads does not provide any real benefit. If all the accept threads are blocked waiting for server thread, new client requests will then be queued until it can be accepted. The number of requests that can be queued is controlled by the backlog and can be useful in managing sudden bursts in requests.

If take an example with a socket server invoker that has max pool set to 300, accept threads is 2, and backlog is 200, will be able to make 502 concurrent client calls. The 503rd client request will get an exception immediately. However, this does not mean all 502 requests will be guaranteed to be processed, only the first 300 (as they have server threads available to do the processing). If 202 of the server threads finish processing their requests from their initial client connections and the connection is released before the timeout for the other 202 that are waiting (200 for backlog and 2 for accept thread), then they will be processed (of course this is a request by request determination).

### Client Socket Invoker

When the socket client invoker makes its first invocation, it will check to see if there is an available socket connection in its pool. Since is the first invocation, there will not be and will create a new socket connection and use it for making the invocation. Then when finished making invocation, will return the still active socket connection to the pool. As more client invocations are made, is possible for the number of socket connections to reach the maximum allowed (which is controlled by ‘clientMaxPoolSize’ property). At this point, when the next client invocation is made, it will keep trying to get an available connection from the pool, waiting 1 second in between tries for up to maximum number of retries (which is controlled by the numberOfRetries property). If runs out of retries, will throw SocketException saying how long it waited to find available socket connection.

Once the socket client invoker goes get an available socket connection from the pool, are not out of the woods yet. There is still a possibility that the socket connection returned, while still appearing to be valid, has timed out while sitting in the pool. So if discover this while trying to make invocation, will throw it away and retry the whole process again. Will do this up to the number set by the numberOfCallRetries before throwing an exception. The trick here is that when get to numberOfCallRetries—2, will assume that any socket connection gotten from the pool will have timed out and will flush the pool all together so that the next retry will cause a new socket connection to be recreated. A typical scenario when this might occur is when have had a burst of client invocations and then a long period of inactivity.

### SSL Transports

There are now four transports that support SSL: https, sslmultiplex, sslrmi, and sslsocket (plus sslservlet, which is not relevant here). All of the preceding discussion applies to each of these, and, moreover, they are all extensions of their non-ssl counterparts, so only some ssl specific information will be added here.

### HTTPS

Configuration of the https transport is a bit different from that of the other transports since the implementation is based off the Tomcat connectors. One difference is that, in order to use SSL connections, the SSLImplementation attribute must be set and must always have the value org.JBoss.remoting.transport.coyote.ssl.RemotingSSLImplementation. The SSLImplementation is used by the Tomcat connector to create ServerSocketFactorys, and RemotingSSLImplementation presents Tomcat with the ServerSocketFactory configured according to the options described above.

### SSLMULTIPLEX

The sslmultiplex server invoker inherits from the socket server invoker a method with signature which supports dynamic replacement of server socket factories. The principal motivation for this facility is to be able to swap in a new SSLServerSocketFactory configured with an updated keystore.

### SSLRMI

The extra twist in the sslrmi invoker is that the server invoker creates the (client) socket factory and packages it with its own stub, from which it follows that the socket factory must be serializable. If the sslrmi server invoker is allowed to create an SSLSocketFactory from SSL parameters, it will take care to create a serializable socket factory. In particular, the server invoker creates a copy of org.JBoss.remoting.transport.rmni. ssl.SerializableSSLClientSocketFactory, which is essentially just a holder for the configuration map passed to the server invoker, with any parameters removed which concern trust store and key store configuration. On the client side, when an sslrmi client invoker is created, it stores its own configuration map in a static variable which the transferred SerializableSSLClientSocketFactory can retrieve and merge with the configuration information it brought with it from the server. In particular, if a socket factory is explicitly passed to the client invoker, then SerializableSSLClientSocketFactory will use it. If not, then SerializableSSLClientSocketFactory will use any key store and trust store information passed to the client to create and configure a socket factory.

### SSLSOCKET

In addition to the various configuration options discussed above, the sslsocket transport exposes the public void setServerSocketFactory(ServerSocketFactory serverSocketFactory) method as a JMX operation.

Also, the sslsocket server invoker inherits from the socket server invoker a method with signature public void setNewServerSocketFactory(ServerSocketFactory serverSocketFactory) which supports dynamic replacement of server socket factories. The principal motivation for this facility is to be able to swap in a new SSLServerSocketFactory configured with an updated keystore.

### SSL SOCKET BUILDER

Throughout this section reference has been made to SSL socket factory and server socket factory configuration parameters. This subsection will introduce these parameters in the context of configuring org.JBoss.remoting.security.SSLSocketBuilder, Remoting's flexible, highly customizable master factory for creating socket and server socket factories. It can be used programmatically on both the client and server side, and it is also a service MBean, so it can be configured and started from within a service xml in a JBossAS environment.

Once a SSLSocketBuilder has been constructed and configured, a call to its method createSSLServerSocketFactory( ) will return a custom instance of a SSLServerSocketFactory, and a call to createSSLSocketFactory( ) will return a custom instance of SSLSocketFactory.

There are two modes in which the SSLSocketBuilder can be run. The first is the default mode where all that is needed is to declare the SSLSocketBuilder and set the system properties javax.net.ssl.keyStore and javax.net.ssl.keyStorePassword. This will use the JVM vendor's default configuration for creating the SSL server socket factory.

In order to customize any of the SSL properties, the first requirement is that the default mode is turned off. This is IMPORTANT because otherwise, if the default mode is not explicitly turned off, all other settings will be IGNORED, even if they are explicitly set. To turn off the default mode via service xml configuration, set the UseSSLServerSocketFactory attribute to false. This can also be done programmatically by calling the setUseSSLServerSocketFactory( ) and passing false as the parameter value.

There are two ways to configure a SSLSocketBuilder: (1) set its bean attributes, either programmatically or by xml configuration, or (2) pass to a SSLSocketBuilder constructor a configuration map with keys defined in the SSLSocketBuilder class.

If any of the attributes KeyStoreURL, KeyStorePassword, KeyStoreType, TrustStoreURL, TrustStorePassword, or TrustStoreType are left unconfigured, SSLSocketBuilder will also examine the corresponding standard SSL system properties “javax.net.ssl.keyStore”, “javax.net.ssl.keyStorePassword”, “javax.net.ssl.keyStoreType”, “javax.net.ssl.trustStore”, “javax.net.ssl.trustStorePassword”, “javax.net.ssl.trustStoreType”. In the cases of KeyStoreType and TrustStoreType, SSLSocketBuilder will then go on to use default values after checking the system properties.

It is also possible to set the default socket factory to be used when not using customized settings (meaning UseSSLSocketFactory property value is true, which is the default). This can be done by setting system property of org.JBoss.remoting.defaultSocketFactory to the fully qualified class name of the javax.net.SocketFactory implementation to use. Will then call the getDefaulto method on that implementation to get the SocketFactory instance to use.

### SSLServerSocketFactorvService

Although any server socket factory can be set for the various transports, there is a customizable server socket factory service provided within JBossRemoting that supports SSL. This is the org.JBoss.remoting.security.SSLServerSocketFactoryService class. The SSLServerSocketFactoryService class extends the javax.net.ServerSocketFactory class and also implements the SSLServerSocketFactoryServiceMBean interface (so that it can be set using the socketServerFactory attribute described previously). Other than providing the proper interfaces, this class is a simple wrapper around the org.JBoss.remoting.security. SSLSocketBuilder class.

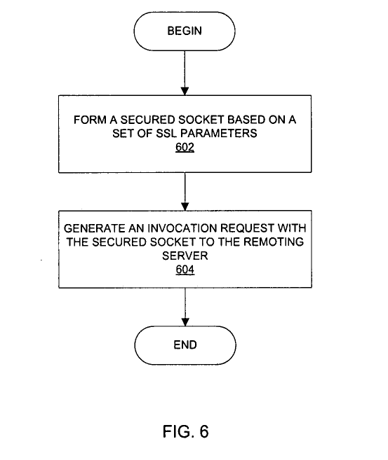

FIG. 6 illustrates a flow diagram of one embodiment of a method for supporting a secure communication between a remoting server and a remoting client. At 602, a secured socket is formed based on a set of SSL parameters. At 604, an invocation request is generated with the secured socket to the remoting server. In one embodiment, the set of SSL parameters is based on keys of a SSL socket builder of the remoting client.

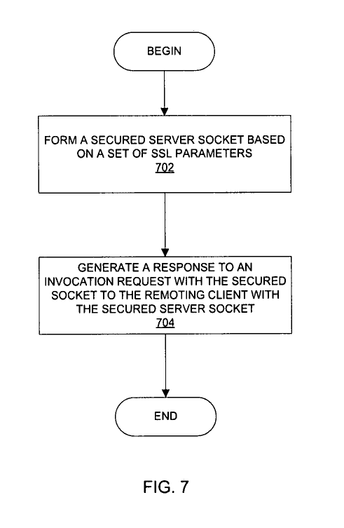

FIG. 7 illustrates a flow diagram of another embodiment of a method for supporting a secure communication between a remoting server and a remoting client. At 702, a secured server socket is formed based on a set of SSL parameters. At 704, a response to an invocation request is generated with the secured socket to the remoting client. In one embodiment, the set of SSL parameters is based on keys of a SSL socket builder of the remoting client.

In the above description, numerous details were set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-accessible storage medium includes any mechanism for storing or transmitting information in a form readable by a machine (e.g., a computer). For example, a machine-accessible storage medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Thus, a method and apparatus for providing compatibility between a remoting client and a remoting server has been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method for supporting a secure communication between a remoting client and a remoting server, the method comprising:
forming a secured socket based on a set of SSL parameters; and
generating an invocation request with the secured socket to the remoting server,
wherein the set of SSL parameters is based on keys of a SSL socket builder of the remoting client.

2. The method of claim 1 wherein forming the secured socket further comprises:
generating a key entry into a keystore file for the remoting server;
forming a certificate based on the keystore; and
importing the certificate into a truststore file for the remoting client.

3. The method of claim 1 further comprising:
providing an authentication certificate of the remoting client to the remoting server; and
establishing the secure communication based on the secured socket.

4. The method of claim 1 further comprising:
configuring the remoting client to determine which remoting client key is to be published and which remoting server certificate is to be accepted.

5. The method of claim 1 wherein an SSL transport of the remoting client further comprises HTTPS, SSL multiplex, SSL RMI, and SSL Socket.

6. A computer-implemented method for supporting a secure communication between a remoting client and a remoting server, the method comprising:
forming a secured server socket based on a set of SSL parameters; and
generating a response to an invocation request with the secured socket to the remoting client,
wherein the set of SSL parameters is based on keys of a SSL socket builder of the remoting client.

7. The method of claim 6 wherein forming the secured socket further comprises:
generating a key entry into a keystore file for the remoting server;
forming a certificate based on the keystore; and
importing the certificate into a truststore file for the remoting client.

8. The method of claim 6 further comprising:
receiving an authentication certificate of the remoting client to the remoting server; and
establishing the secure communication based on the secured socket.

9. The method of claim 6 further comprising:
configuring the remoting server to determine which remoting client certificate is to be accepted.

10. The method of claim 6 wherein an SSL transport of the remoting server further comprises HTTPS, SSL multiplex, SSL RMI, and SSL Socket.

11. A remoting client comprising:
a client remote access application; and
a socket client invoker coupled to the client remote access application to obtain a secure socket for generating an invocation request to a remoting server, wherein the socket client invoker is to form the secured socket based on a set of SSL parameters,
wherein the set of SSL parameters is based on keys of a SSL socket builder of the remoting client.

12. The remoting client of claim 11 wherein the socket client invoker is to generate a key entry into a keystore file for the remoting server, to form a certificate based on the keystore, and to import the certificate into a truststore file for the remoting client.

13. The remoting client of claim 11 wherein the socket client invoker is to provide an authentication certificate of the remoting client to the remoting server, and to establish the secure communication based on the secured socket.

14. The remoting client of claim 11 wherein the remoting client is configure to determine which remoting client key is to be published and which remoting server certificate is to be accepted.

15. The remoting client of claim 11 wherein an SSL transport of the remoting client further comprises HTTPS, SSL multiplex, SSL RMI, and SSL Socket.

16. A remoting server comprising:
an invocation handler; and
a socket server invoker coupled to the invocation handler to obtain a secure socket for generating a response an invocation request to a remoting client, wherein the socket server invoker is to form the secured socket based on a set of SSL parameters,
wherein the set of SSL parameters is based on keys of a SSL socket builder of the remoting client.

17. The remoting server of claim 16 wherein the socket server invoker is to generate a key entry into a keystore file for the remoting server, form a certificate based on the keystore, and import the certificate into a truststore file for the remoting client.

18. The remoting server of claim 16 wherein the socket server invoker is to receive an authentication certificate of the remoting client at the remoting server, and to establish the secure communication based on the secured socket.

19. The remoting server of claim 16 wherein the socket server invoker is to configure the remoting server to determine which remoting client certificate is to be accepted.

20. The remoting server of claim 16 wherein an SSL transport of the remoting server further comprises HTTPS, SSL multiplex, SSL RMI, and SSL Socket.

21. An article of manufacture comprising:
a machine-accessible storage medium including data that, when accessed by a machine, cause the machine to perform a method for supporting a secure communication between a remoting client and a remoting server, the method comprising:
forming a secured socket based on a set of SSL parameters; and
generating an invocation request with the secured socket to the remoting server,
wherein the set of SSL parameters is based on keys of a SSL socket builder of the remoting client.

22. The article of manufacture of claim 21 wherein forming the secured socket further comprises:
generating a key entry into a keystore file for the remoting server;
forming a certificate based on the keystore; and
importing the certificate into a truststore file for the remoting client.

23. The article of manufacture of claim 21 wherein the method further comprises:
providing an authentication certificate of the remoting client to the remoting server; and
establishing the secure communication based on the secured socket.

24. The article of manufacture of claim 1 wherein the method further comprises:
configuring the remoting client to determine which remoting client key is to be published and which remoting server certificate is to be accepted.

25. The article of manufacture of claim 1 wherein an SSL transport of the remoting client further comprises HTTPS, SSL multiplex, SSL RMI, and SSL Socket.

26. An article of manufacture comprising:
a machine-accessible storage medium including data that, when accessed by a machine, cause the machine to perform a method for supporting a secure communication between a remoting client and a remoting server, the method comprising:
forming a secured server socket based on a set of SSL parameters; and
generating a response to an invocation request with the secured socket to the remoting client,
wherein the set of SSL parameters is based on keys of a SSL socket builder of the remoting client.

27. The article of manufacture of claim 26 wherein forming the secured socket further comprises:
generating a key entry into a keystore file for the remoting server;
forming a certificate based on the keystore; and
importing the certificate into a truststore file for the remoting client.

28. The article of manufacture of claim 26 wherein the method further comprises:
receiving an authentication certificate of the remoting client to the remoting server; and
establishing the secure communication based on the secured socket.

29. The article of manufacture of claim 26 wherein the method further comprises:
configuring the remoting server to determine which remoting client certificate is to be accepted.

30. The article of manufacture of claim 26 wherein an SSL transport of the remoting server further comprises HTTPS, SSL multiplex, SSL RMI, and SSL Socket.
